(19) United States
(12) Patent Application Publication
(10) Pub. No.: US 2013/0025984 A1
(43) Pub. Date: Jan. 31, 2013

(54) WHEEL SPEED REGULATOR

(71) Applicant: Lior Ferdman, Zoran (IL)

(72) Inventor: Lior Ferdman, Zoran (IL)

(21) Appl. No.: 13/578,819

(22) PCT Filed: Feb. 1, 2011
(86) PCT No.: PCT/IL11/00118

§ 371 Date: Oct. 21, 2012

(30) Foreign Application Priority Data
Feb. 18, 2010 (IL) 204026

(51) Int. Cl. F16D 59/00; B62B 5/04; A61G 5/10; B60T 1/06; A61G 1/04; F16D 51/00; B62B 9/08

(52) U.S. Cl. 188/78

(57) ABSTRACT

A mechanism (13) for regulating a speed of a cart (10) wheel (14), the mechanism (13) comprising: a rotating backing plate (26) affixed to the wheel (14), thereby rotating along with the wheel (14); a stationary drum (22) affixed to the cart (10); one or more brake shoes (30) attached to the rotating backing plate (26) such that upon rotating the wheel (14), the brake shoes (30) apply centrifugal force on the drum (22), thereby braking the rotation of the wheel (14) proportionally to the speed of rotation of the wheel (14); and a spring module (33) for applying a pulling force on the brake shoes (30) to draw the brake shoes (30) away from the drum (22), wherein the spring module comprise a spring lever for adjusting the preset speed of the wheel thereby allowing resembling the moving characteristics of the cart, providing stable movement of the cart.

### FIELD OF THE INVENTION

The present invention relates to the field of human-powered transport. More particularly, the invention relates to a method and apparatus for regulating a speed of a wheel on a wheeled vehicle powered by a human.

### BACKGROUND OF THE INVENTION

Wheeled vehicles powered by humans have existed for many centuries, and possibly for many millenniums following the advent of the wheel. Modern types of wheeled human-powered vehicles may be used for transporting people such as, for example, a baby stroller, a wheelchair, and a stretcher, among others. Other wheeled human-powered vehicles may be used for transporting goods such as, for example, a shopping cart, and a wheelbarrow.

In a typical use, a human-powered wheeled vehicle may be required to descend an inclination which may be at times relatively steep. During the descent, the vehicle may tend to accelerate (due to gravity) so that a user of the vehicle, either pushing it or being transported by it (for example in the case of a wheelchair) may be required to exert a relatively large force to counter the acceleration of the vehicle. Occasionally, the user may lose control of the vehicle resulting in an accident. Numerous braking systems are known in the art for attempting to control the acceleration of the vehicle.

These include the following:

US 2008/0029982 relates to “A stroller is provided having a stroller frame supported by at least one wheel and a handle. The handle includes a brake operator that is coupled to a brake assembly at the wheel. The brake operator is movable between a first position whereby the brake assembly is disengaged from the wheel, and a second position whereby the brake assembly engages the wheel to retard the wheel motion.”

U.S. Pat. No. 7,255,206 relates to “Shopping cart brakes slow or render a shopping cart immobile. A brake lever has one end pivotally connected to a clamp that is attached to one end of a vertical member of a shopping cart adjacent to its handle. Two brake cables are enclosed by brake cable housings and have one end connected to the brake lever. A plurality of brake cable supports secures the brake cable housings to the vertical member. Alternatively, the brake cables and brake cable housings can be enclosed by vertical members and a horizontal member. The opposing end of the brake cables is attached to calipers. The calipers have brake pads removably connected to them. A brake lever housing is also connected to the clamp. The brake lever housing is attached to an adjuster barrel and houses a brake lever locking mechanism comprising a locking tab, locking button, slot, and locking button hole.”

U.S. Pat. No. 7,316,298 relates to “This invention relates to gravity reactive braking systems. According to the invention there is provided a brake system to control speed in a forward direction for descending inclined surfaces and a brake system for controlling rollback when ascending an inclined surface. The speed pacer braking assembly includes a downhill activator for selectively engaging a disc brake system when a predetermined inclined is reach. The anti-rollback assembly comprises a pair of graded brake cam structures operatively disposed adjacent wheels wherein the natural pull of gravity and the configuration of the cams operate to allow passage of wheels in both directions when on flat surfaces and in only a single direction when on an incline. When on an incline, gravity operates to dispose cams relative to the wheels such that rotation of wheels in one direction is hindered by a thickening of cam body caused by rotation of cam about its axis. Both systems include adjustment means for setting the incline angle at which brake assemblies will operate to hinder wheel rotation in the undesired direction.”

U.S. Pat. No. 7,144,025 relates to “A wheelchair is disclosed that includes a seat; a pair of wheels, a detection part indicating the presence or absence of a user on the seat, electric brake units switching between applying braking forces to and releasing braking forces from the wheels based on control signals, and a control part connected to the detection part and the electric brake units and outputting the control signals to the electric brake units. The control signals include a first control signal causing the braking forces by the electric brake units to be applied to the wheels and a second control signal causing the braking forces by the electric brake units to be released therefrom. The first control signal is output when the detection part indicates the absence of the user on the seat, and the second control signal is output when the detection part indicates the presence of the user on the seat.”

Other prior art includes US 2008/0073878; U.S. Pat. No. 6,382,364; JP 9,039,800; JP 59164424; U.S. Pat. No. 3,642,328; and GB 2335957.

It is an object of the present invention to provide a solution to the above-mentioned and other problems of the prior art.

Other objects and advantages of the invention will become apparent as the description proceeds.

### SUMMARY OF THE INVENTION

There is provided, in accordance with an embodiment of the present invention, a mechanism (13) for regulating a speed of a cart (10) wheel (14), the mechanism (13) comprising a rotating backing plate (26) affixed to the wheel (14), thereby rotating along with the wheel (14); a stationary drum (22) affixed to the cart (10); one or more brake shoes (30) attached to the rotating backing plate (26) such that upon rotating the wheel (14), the brake shoes (30) apply centrifugal force on the drum (22), thereby braking the rotation of the wheel (14) proportionally to the speed of rotation of the wheel (14); and a spring module (33) for applying a pulling force on the brake shoes (30) to draw the brake shoes (30) away from the drum (22), wherein the spring module comprise a spring lever (34) for adjusting the preset speed of the wheel thereby allowing resembling the moving characteristics of the cart, providing stable movement of the cart. Optionally, each of the break shoes (30) further comprises a weight, for increasing the force applied by the break shoe.

In some embodiments of the present invention, the spring module (33) comprises a spring (32) attachable to the brake shoe (30) for applying the pulling force. Optionally, the spring (32) comprises a helical spring. Optionally, the spring (32) comprises an elastically deformable device. Additionally or alternatively, the elastically deformable device comprises an elastic band.

Optionally, the spring module (33) comprises a speed adjustment lever (20) for selecting a preset speed of the cart (10).

In some embodiments of the present invention, the mechanism (13) further comprises a brake lining (38) for frictionally contacting the stationary drum (22). Optionally, the mechanism (13) further comprises a speed adjustment scale (16).

There is provided, in accordance with an embodiment of the present invention, a method for regulating the speed of a cart (10) wheel (14), the method comprising the steps of providing a brake system (22) for braking the wheel (14), providing a module (33) for applying a centrifugal force caused by the rotation of the wheel (14) on the brake system (22), thereby upon rotating the wheel (14), applying braking force on the wheel (14). Optionally, the method further comprises applying a weight for increasing the centrifugal force applied by the module (33).

In some embodiments of the present invention, the method comprises the steps of providing a spring module (33) for applying an opposing force to the centrifugal force, and providing a spring lever (34) for setting a level of the opposing force, thereby allowing a user to set a speed upon which the brake system (22) begins to brake the wheel (14). Optionally, the method further comprises frictionally contacting the brake system (22).

In some embodiments of the present invention, the cart (10) is a baby stroller. Optionally, the cart (10) is a wheelchair. Additionally or alternatively, the cart (10) is a stretcher. Optionally, the cart (10) is a shopping cart.

There is provided, in accordance with an embodiment of the present invention, a method for, substantially as described and illustrated.

The foregoing embodiments of the invention are described and illustrated in conjunction with systems and methods thereof, which are meant to be merely illustrative, and not limiting.

### BRIEF DESCRIPTION OF THE DRAWINGS

Embodiments and features of the present invention are described herein in conjunction with the following drawings:

FIG. 1 schematically illustrates a perspective view of an exemplary human-powered vehicle, for example a baby stroller, including a speed regulating mechanism forming part of a rear wheel, according to an embodiment of the present invention;

FIG. 2 schematically illustrates a perspective enlarged view of the wheel including the speed regulating mechanism shown in FIG. 1, according to an embodiment of the present invention;

FIG. 3 schematically illustrates a partially exploded view of an interior of the speed regulating mechanism of FIGS. 1-2, according to an embodiment of the present invention;

FIG. 4 schematically illustrates an exploded view of the speed regulating mechanism of FIGS. 1-3, according to an embodiment of the present invention; and

FIG. 5 schematically illustrates a perspective view of an exemplary human-powered vehicle, for example a baby stroller, including a speed regulating mechanism attached to a rear wheel through a rotary axle, according to some embodiments of the present invention.

It should be understood that the drawings are not necessarily drawn to scale.

### DETAILED DESCRIPTION OF PREFERRED EMBODIMENTS

The present invention will be understood from the following detailed description of preferred embodiments, which are meant to be descriptive and not limiting. For the sake of brevity, some well-known features, methods, systems, procedures, components, circuits, and so on, are not described in detail.

An aspect of some embodiments of the present invention relates to a braking mechanism for regulating a speed of a human-powered vehicle according to a preset speed of a user. For convenience hereinafter, the “human-powered vehicle” may be used interchangeably with “vehicle”, “wheeled vehicle”, “wheeled human-powered vehicle”, “human-powered wheeled vehicle”, and “cart”. Optionally, the vehicle may be mechanically and/or electrically powered, for example, by a motor. The mechanism, which is attached (affixed) to a wheel of the vehicle, includes a brake shoe which applies a centrifugal braking force to a brake drum proportional to a speed of rotation of the wheel. When a speed of the vehicle (which is associated with a rotational speed of the wheel) exceeds, or optionally reaches, a preset speed the brake shoe is centrifugally thrust against the drum, frictionally contacting the drum and slowing down the wheel. The wheel is then slowed down to a rotational speed where the speed of the vehicle does not exceed, or optionally reach, the preset speed. Optionally, the centrifugal force and the frictional contact between the brake shoe and the drum increase as the speed of the vehicle increases according to the preset speed. Optionally, the brake shoe is weighted to increase the centrifugal force exerted on the drum.

According to some embodiments of the present invention, the mechanism includes a spring module with a return spring for applying a pulling force to the brake shoe pulling the brake shoe away from the drum. The pulling force, which may be adjusted by a speed adjustment lever, is set by the user when selecting the preset speed. When the speed of the vehicle exceeds, or optionally reaches, the preset speed, the centrifugal force generated by the rotational speed of the wheel overcomes the pulling force of the spring allowing the brake shoe to come into frictional contact with the drum and slowing the wheel down. As the wheel slows down the centrifugal force generated by the wheel's rotation decreases and is overcome by the pulling force of the return spring which pulls the brake shoe away from the drum. Optionally, the return spring includes a helical (coil) spring. Optionally, the return spring may include any elastically deformable component suitable for pulling the brake shoe away from the drum when the centrifugal force generated by the wheel's rotation is less than the pulling force of the elastic component. For example, the elastically deformable component may be an elastic band.

According to some embodiments of the present invention, the speed regulating mechanism may form part of the wheel. Optionally, the mechanism may be externally connected to the wheel. Optionally, the connection may be through an axle of the wheel. The mechanism may include two shoes for frictionally contacting the drum over a relatively large area. Optionally, the mechanism may include only one brake shoe. Additionally or alternatively, the mechanism may include more than two brake shoes, for example, three brake shoes, 4 brake shoes, or more. The shoes are pivotally connected to a rotating backing plate configured to rotate about a stationary axle of the vehicle wheel, and further configured to rotate inside the drum which is attached to the axle. Optionally, the base plate may be attached to a rotatory axle and rotates inside the stationary drum (which may be, for example, stationary attached to stroller 10). As the wheel rotates, the brake shoe pivots on the backing plate towards the drum as the centrifugal force overcomes the pulling force of the return spring. When the centrifugal force is overcome by the pulling force the brake shoe pivots back to a non-contact position as the wheel slows down to, or below, the preset speed. Optionally, the brake shoe may be weighted (weight is added to the brake shoe) so as to increase the centrifugal force on the drum.

According to some embodiments of the present invention, the human-powered vehicle may be for transporting people such as, for example, a baby stroller, a wheelchair, or a stretcher, among others. Optionally, the human-powered vehicle may be used for transporting goods such as, for example, a shopping cart, or a wheelbarrow, among others.

According to some embodiments of the present invention, the cart may be mechanically and/or electrically powered, for example, by a motor. Optionally, the motor may drive one or more wheels in the cart. Optionally, the motor may be operational while the vehicle is being pushed by a user so as to assist the user. Optionally, the motor may operate independently of a user (without a user pushing the vehicle).

In the figures and/or description herein, the following reference numerals have been mentioned:

| Item Description | Number |
|---|---|
| Baby carriage or stroller | 10 |
| Front wheel | 12 |
| Speed regulating mechanism | 13 |
| Rear wheel | 14 |
| Rear wheel axle | 15 |
| Speed adjustment scale | 16 |
| Rear wheel axle | 18 |
| Speed adjustment lever | 20 |
| Drum | 22 |
| Threaded male fastener | 24 |
| Backing plate | 26 |
| Threaded hole | 28 |
| Brake shoe | 30 |
| Return spring | 32 |
| Spring module | 33 |
| Spring lever | 34 |
| Spring lever pin | 36 |
| Brake lining | 38 |
| Brake shoe pin | 40 |
| Brake shoe opening | 42 |
| Stroller | 44 |
| Rear wheel | 46 |
| Rear Axle | 47 |
| Speed regulating mechanism | 48 |

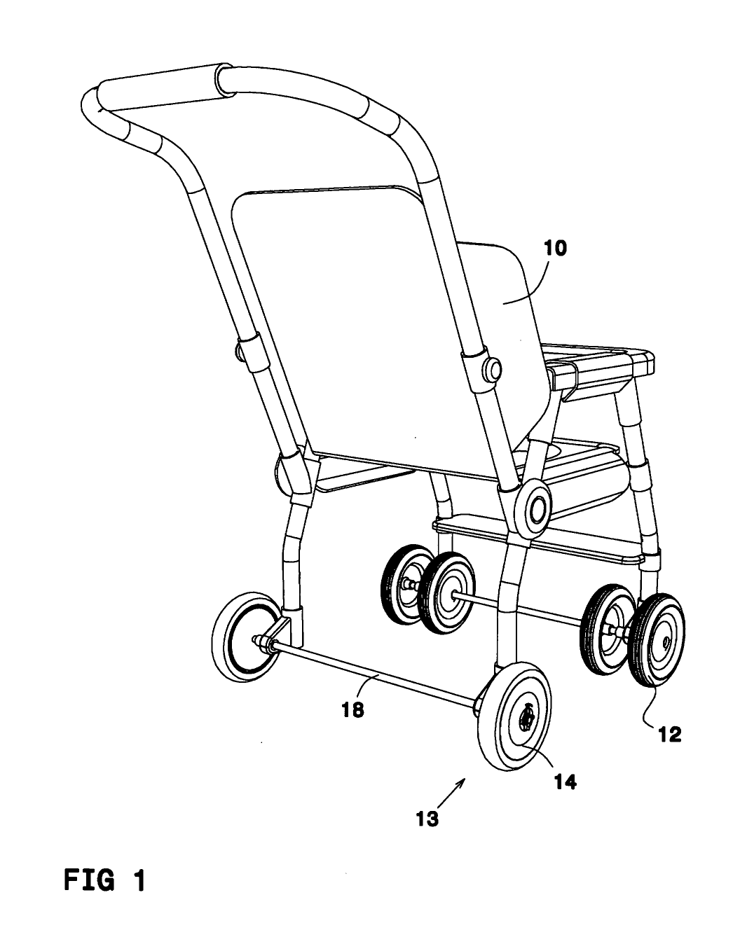

Reference is now made to FIG. 1 which schematically illustrates a perspective view of an exemplary human-powered vehicle, for example a baby stroller 10, including a speed regulating mechanism 13 forming part of a rear wheel 14, according to an embodiment of the present invention. Rear wheel 14 is configured to rotate about a stationary rear axle 18. Optionally, rear axle 18 may be rotatory. Optionally, speed regulating mechanism 13 may be attached to a front wheel 12 of stroller 10. Speed regulating mechanism 13 is configured to regulate a speed of stroller 10 such that it does not exceed, or optionally reach, a preset speed selected by a user. Additionally or alternatively, mechanism 13 is configured so that no preset speed is selected by the user (mechanism is deactivated).

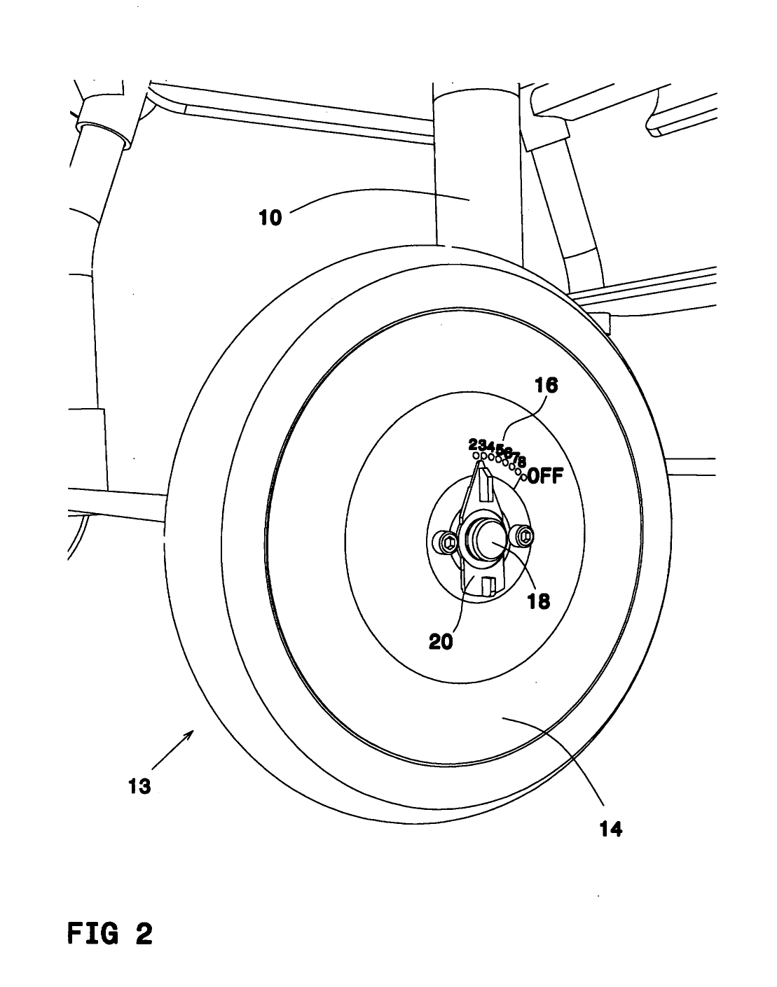

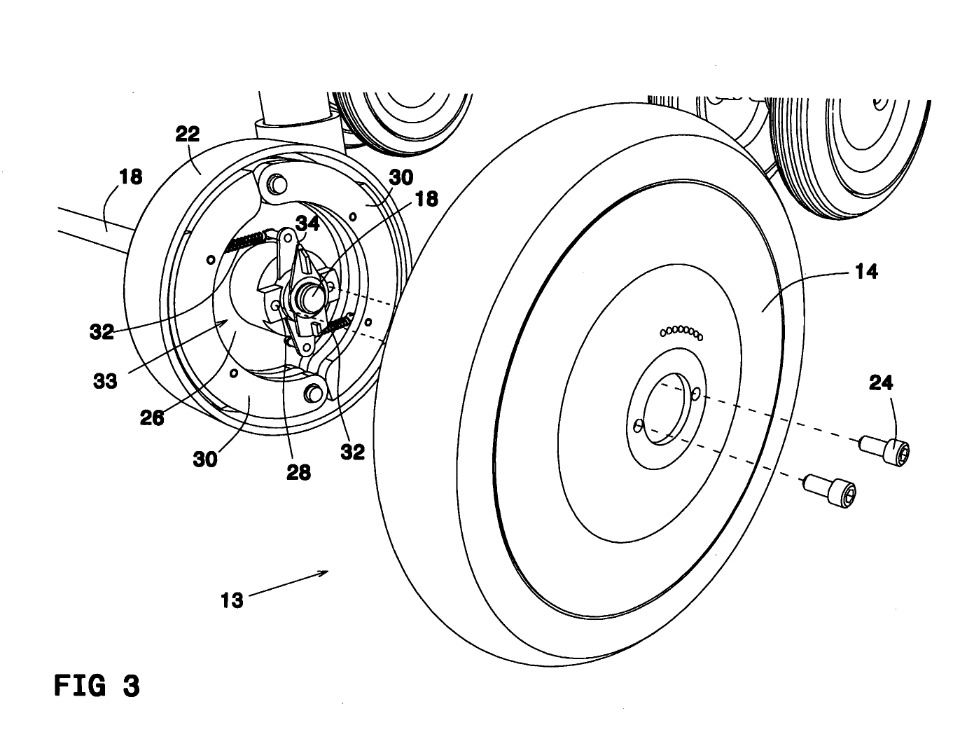

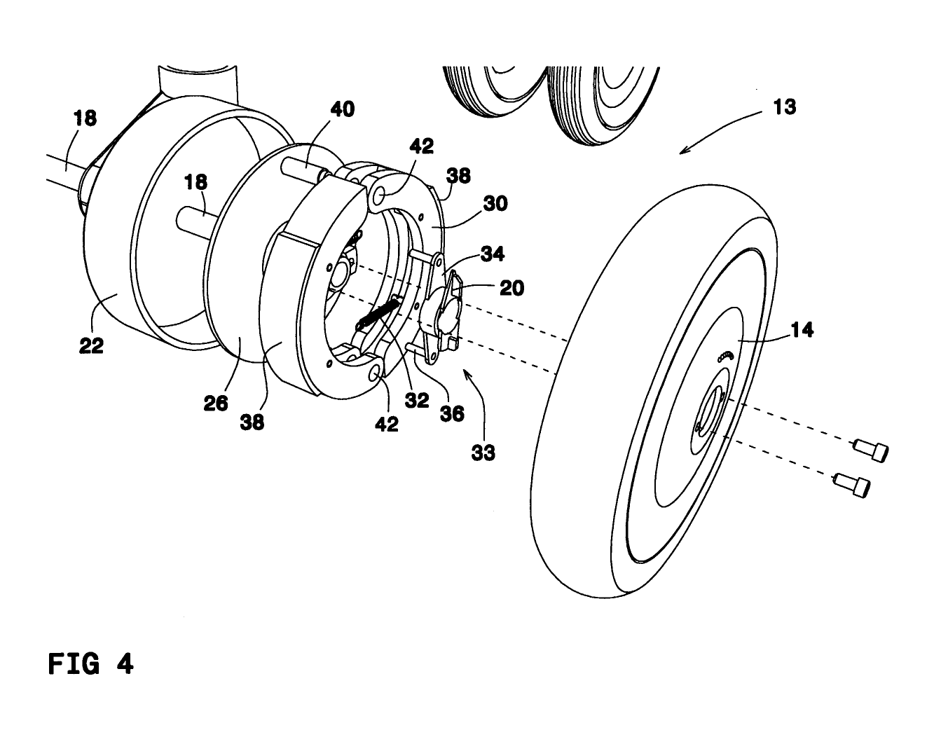

Reference is now also made to FIG. 2 which schematically illustrates a perspective enlarged view of wheel 14 including mechanism 13, to FIG. 3 which schematically illustrates a partially exploded view of an interior of the mechanism, and to FIG. 4 which schematically illustrates an exploded view of the mechanism, all according to an embodiment of the present invention. Speed regulating mechanism 13 includes a drum 22 attached to rear axle 18, a rotating backing plate 26 to which wheel 14 is attached and configured to rotate inside the drum and about the rear axle, and a speed adjustment lever 20 for allowing the user to set the preset speed of stroller 10. Optionally, speed adjustment lever 20 may be preset by the user according to a preset speed scale 16 shown on the wheel, for example, as shown with speeds ranging from 2 kph (kilometers per hour) up to 8 kph. Optionally, the user rotates lever 20 to set the preset speed. Additionally or alternatively, the user may rotate position speed adjustment lever 20 to an “OFF” position, deactivating mechanism 13. Wheel 14 is attached to backing plate 26 by means of threaded male fasteners 24 inserted into threaded holes 28 in the plate. Optionally, wheel 14 covers drum 22 and rotates around the drum.

According to some embodiments of the present invention, backing plate 26 includes a brake shoe pin 40 onto which may be fitted a brake shoe 30 by slidingly fitting the brake shoe pin into a brake shoe opening 42 located at one end of the brake shoe. Optionally, backing plate 26 includes two brake shoe pins 40 for accommodating two brake shoes 30. Optionally, backing plate 26 may be configured to accommodate only one brake shoe 26, or more than two brake shoes. Brake shoe 30 is configured to pivot about braking shoe pin 40 in a direction towards drum 22 due to a centrifugal force generated by the rotation of backing plate 26 (with wheel 14). Optionally, brake shoe 30 may be weighted for increasing the centrifugal force of the shoe brake. Optionally, the greater the rotational speed of backing plate 26, the greater the centrifugal force of brake shoe 30. Brake shoe 30 includes a brake lining 38 for frictionally contacting drum 22 when the centrifugal force of the brake shoe due to rotation of backing plate 26 (and wheel 14) exceeds a pulling force of a return spring 32 acting on each brake shoe, and causes the brake shoe to pivot against the drum.

According to some embodiments of the present invention, mechanism 13 may include a spring module 33 which includes two return springs 32, each attached at one end to a brake shoe 30 and at another end to a spring lever pin 36 on opposing ends of a rotary spring lever 34; and speed adjustment lever 20. Optionally, spring module 33 may include only one return spring 32 attached at one end to brake shoe 30 and at another end to one spring lever pin 36 on one end of rotary spring lever 34. Optionally, spring module 33 may include more than two return springs 32 and more than two spring lever pins 36 for attaching the more than two brake shoes 30 to the spring module; for example, 3 brake shoes, 4 brake shoes, or more.

According to some embodiments of the present invention, spring module 33 is configured to allow a user to set the preset speed of stroller 10 by setting a position of speed adjustment lever 20 to a desired preset speed on speed adjustment scale 16. Optionally, the position of speed adjustment lever 20 may be set by the user rotating the lever to the preset speed. Setting speed adjustment lever 20 to the preset speed manipulates spring lever 34 to a position where each spring lever pin 36 pulls on respective return spring 32 attached to it, and exerts a pulling force on respective brake shoe 30 attached to the spring in a direction away from drum 22 (opposing the centrifugal force of the brake shoe). A magnitude of the pulling force is proportional to the desired preset speed such that, the greater the preset speed, the greater the pulling force on brake shoe 30. Optionally, return spring 32 is a helical (coil) spring. Optionally, return spring 32 may include any elastically deformable device suitable for pulling brake shoe 30 away from drum 20 when the centrifugal force generated by wheel 14 rotation (or backing plate 26 rotation) is less than the pulling force of the elastic device. Optionally, return spring 32 may include an elastic band.

Following is a description of a typical non-limiting mode of operation of mechanism 13 in stroller 10, according to some embodiments of the present invention.

Speed adjustment lever 20 is rotated by the user, setting the preset velocity of stroller 10 on speed adjustment scale 16, for example to 4 kph. Rotation of speed adjustment lever 20 rotates spring lever 34 to a position where the pulling force exerted by return springs 32 on brake shoes 30 may only be counteracted (and overcome) by the centrifugal force of the brake shoes due to the speed of rotation of backing plate 26 (and wheel 14) when the velocity of stroller 10 is greater than the preset speed. When the stroller 10 speed exceeds, or optionally reaches, the preset speed, the centrifugal force causes brake shoes 30 to pivot about brake shoe pin 40 towards drum 20 and brake lining 38 frictionally contacts the drum. The frictional contact slows down the speed of rotation of backing plate 26 (and wheel 14) until the speed of stroller 10 is equal to, or optionally less than, the preset speed. As backing plate 26 slows down, the centrifugal force of brake shoes 30 decreases and is overcome by the pulling force of return springs 32, causing the brake shoes to pivot away from drum 22 (to a non-contact position). The pulling force is maintained on brake shoes 30 so that the brake shoes may not pivot towards drum 22 and may not apply the centrifugal force again to the drum until the speed of stroller 10 again exceeds, or optionally reaches, the preset speed. Selecting a higher preset speed by rotating speed adjustment lever 20 to a higher speed on speed adjustment scale 16 increases causes a greater rotation of spring lever 34 and an increase in the pulling force of return spring 32. As a result, a greater centrifugal force proportional to a greater rotational speed of backing plate 26 may be required to overcome the greater pulling force. Selecting a lower preset speed causes a lesser rotation of spring lever 34 and a decrease in the pulling force of return spring 32. As a result, a lesser centrifugal force proportional to a lesser rotational speed of backing plate 26 may be required to overcome the lesser pulling force. Optionally, the preset speed may be overridden by rotating speed adjustment lever 20 to an “OFF” position, so that there is no pulling force on brake shoes 30.

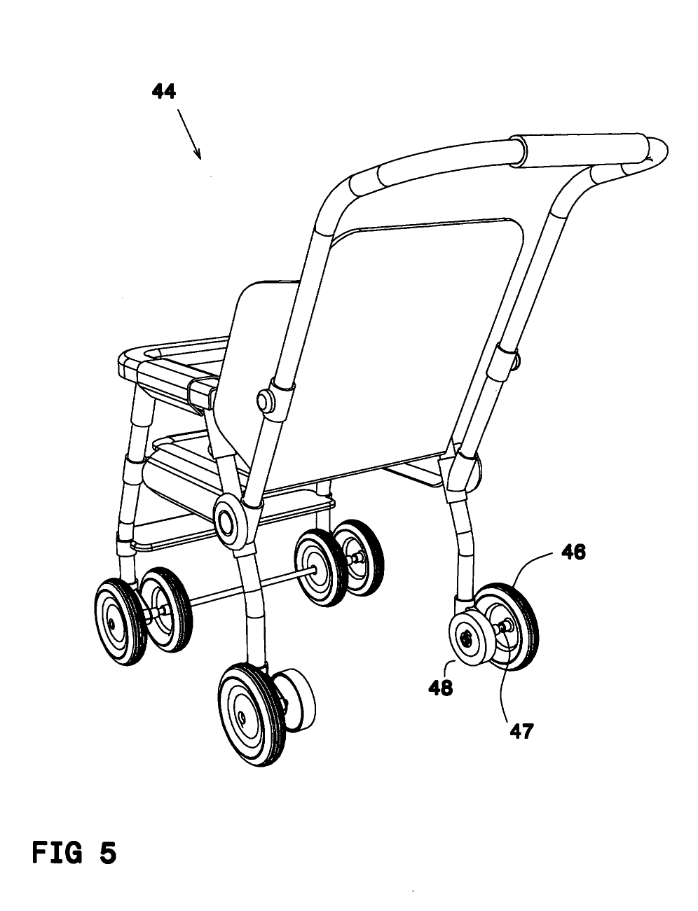

Reference is now made to FIG. 5 which schematically illustrates a perspective view of an exemplary human-powered vehicle, for example a baby stroller 44, including a speed regulating mechanism 48 attached to a rear wheel 46 through a rotary axle 47, according to some embodiments of the present invention. Speed regulating mechanism 48 may be similar to that shown in FIGS. 1-4 at 13, with a difference that speed regulating mechanism 48 may be configured to regulate a rotation speed of rear wheel 46 by regulating a rotational speed of rotary rear axle 47.

The foregoing description and illustrations of the embodiments of the invention has been presented for the purposes of illustration. It is not intended to be exhaustive or to limit the invention to the above description in any form.

Any term that has been defined above and used in the claims, should to be interpreted according to this definition.

What is claimed is:

1. A mechanism for regulating a speed of a cart wheel, said mechanism comprising:
a rotating backing plate affixed to said wheel, thereby rotating along with said wheel;
a stationary drum affixed to said cart;
one or more brake shoes attached to said rotating backing plate such that upon rotating said wheel, said brake shoes apply centrifugal force on said drum, thereby braking the rotation of said wheel proportionally to the speed of rotation of said wheel; and
a spring module for applying a pulling force on the brake shoes to draw the brake shoes away from the drum, said spring module comprising a spring lever for adjusting the preset speed of said wheel,
thereby allowing resembling the moving characteristics of the wheels of said cart, providing stable movement of said cart.

2. A mechanism according to claim 1, wherein each of said break shoes further comprises a weight, for increasing the force applied by the break shoe.

3. A mechanism according to claim 1, wherein the spring module comprises a spring attachable to the brake shoe for applying the pulling force.

4. A mechanism according to claim 3, wherein the spring comprises a helical spring.

5. A mechanism according to claim 3, wherein the spring comprises an elastically deformable device.

6. A mechanism according to claim 5, wherein the elastically deformable device comprises an elastic band.

7. A mechanism according to claim 1, wherein the spring module comprises a spring lever for adjusting the pulling force applied on the brake shoes.

8. The mechanism according to claim 1, wherein the cart is a baby stroller.

9. The mechanism according to claim 1, wherein the cart is a wheelchair.

10. The mechanism according to claim 1, wherein the cart is an ambulance stretcher.

11. The mechanism according to claim 1, wherein the cart is a shopping cart.

12. The mechanism according to claim 1, further comprising a brake lining for frictionally contacting the stationary drum.

13. The mechanism according to claim 1, further comprising a speed adjustment scale.

14. A method for regulating the speed of a cart wheel, the method comprising the steps of:
providing a brake system for braking said wheel;
providing a module for applying a centrifugal force caused by the rotation of said wheel on said brake system;
thereby upon rotating said wheel, applying braking force on said wheel;
providing a spring module for applying an opposing force to said centrifugal force; and
providing a spring lever for setting a level of the opposing force;
thereby allowing a user to set a speed upon which said brake system begins to brake said wheel.

15. A method according to claim 14, further comprising the step of applying a weight for increasing the centrifugal force applied by the module.

16. The method according to claim 14, wherein the cart is a baby stroller.

17. The method according to claim 14, wherein the cart is a wheelchair.

18. The method according to claim 14, wherein the cart is an ambulance stretcher.

19. The method according to claim 14, wherein the cart is a shopping cart.

20. The method according to claim 14, further comprising the step of frictionally contacting the brake system.
